(19) United States
(12) Patent Application Publication
(10) Pub. No.: US 2016/0179294 A1
(43) Pub. Date: Jun. 23, 2016

(54) NOTIFICATION DISPLAY

(71) Applicant: HEWLETT-PACKARD DEVELOPMENT COMPANY, L.P., Houston, TX (US)

(72) Inventors: KI-BOK SONG, HOUSTON, TX (US); ERIC CHEN, HOUSTON, TX (US); CHAD PARIS PATRICK, HOUSTON, TX (US)

(21) Appl. No.: 14/906,657

(22) PCT Filed: Sep. 12, 2013
(86) PCT No.: PCT/US2013/059522

§ 371 Date: Jan. 21, 2016

(51) Int. Cl. G06F 3/0481; G06F 3/0488

(52) U.S. Cl. CPC G06F 3/0481; G06F 3/0488

(57) ABSTRACT

A protective cover for a computing device in accordance with an example includes a front side and a back side. The back side includes a display area to display notifications to a user when the protective cover is placed over the computing device. A connector at a bottom portion of the protective cover removably connects to the computing device.

### BACKGROUND

Computing devices come in different sizes, shapes, and features. Over the years, computing devices have become increasingly compact and powerful such that a mobile user is provided with almost the same capabilities and network access offered by traditional fixed (or less mobile) devices. For example, most smartphones and tablet computing devices are ten inches or less in size and provide a touchscreen display for accepting user input and displaying images to the user, as well as computing capabilities that rival desktops and traditional notebook computers.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example of a computing device including a display member and an accessory member to display notifications;

FIG. 2A illustrates examples of notifications that are displayed by an accessory display of the accessory member of FIG. 1;

FIG. 2B illustrates an example of the accessory display of the accessory member of FIG. 1 displaying notifications in response to a finger swipe; and

FIG. 3 illustrates an example of an accessory member for a computing device that includes a keyboard on a front side and a connector on a bottom side to removably connect to the computing device.

### DETAILED DESCRIPTION

A mobile computing device can include a touchscreen for accepting user input and for displaying images to an operating user. For example, a tablet is a personal computer that may be operated by a touchscreen, where the user's finger may function as the mouse and cursor, thereby eliminating the need for a separate mouse and other input devices. The tablet is often thinner and lighter than a notebook computer that includes a keyboard at the base, since the tablet forgoes the physical keyboard. Instead, an onscreen virtual keyboard may be displayed on the display for user input. Thus, the tablet can be used holding the tablet with one or two hands and therefore may be thinner and lighter than a notebook computer. A stylus pen may also be used to provide input.

Because such mobile computing devices are not in a traditional clam shell form, the touchscreen/display is often open and vulnerable to cracks, dirt, smear, etc. To protect the touchscreen and to prolong the life of the touchscreen, computing devices may be accessorized with a protective cover (e.g., removable) to protect the touchscreen. The protective covet may also include a keyboard (e.g., QWERTY) for providing input to the computing device.

With the protective cover, the user is able to easily carry the computing device around without exposing the touchscreen to damage. While carrying the computing device with the protective cover/accessory, the user may desire to view the time (e.g., a digital clock) or any other notifications (e.g., email notification, message notification, etc.). The user may therefore need to open, the protective cover to view the notifications. In some instances, the user may need to wake the computing device from a sleep state or a low power state, or even power up the computing device to view the notifications. This may be time consuming and cumbersome for a user on the move to flip the protective cover to view one or more notifications.

Accordingly, examples described herein address the above challenges by providing a protective cover or accessory member for a computing device that includes a display area for displaying notifications to a user when the protective cover/accessory member is in a closed position over the computing device. In certain examples, the notifications are displayed in response to the user swiping a linger across the display area of the protective cover/accessory. In other examples, the notifications disappear after a preset duration of time to conserve power. Thus, the user may easily access important notifications without having to power up the computing device and/or open the protective cover/accessory, thereby providing added value and functionality for the protective cover/accessory.

If one example, a computing device includes a display member and an accessory member removably connected to the display member. The accessory member includes a front side and a back side. The back side of the accessory member includes an accessory display to display notifications when the accessory member is in a closed position over the display member.

In another example, a protective cover tor a computing device includes a front side and a back side. The back side includes a display area to display notifications to a user when the protective cover is placed over the computing device. The protective cover also includes a connector at a bottom portion to removably connect to the computing device.

In another example, a computing device includes a display member and an accessory member removably connected to the display member. The accessory member includes a treat side and a back side. The front side includes a keyboard and the back side includes an accessory display to display notifications to a user when the accessory member is in a closed position over the display member, and in response to the user swiping a finger across the accessory display.

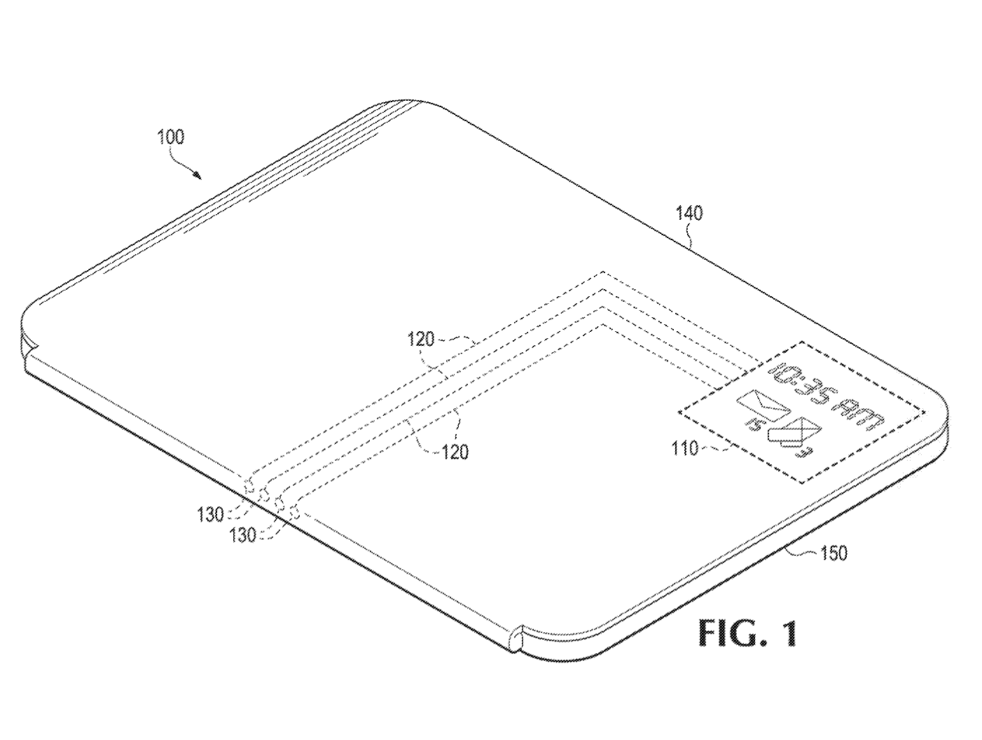

FIG. 1 illustrates an example of a computing device 100 including a display member 150 and an accessory member 140 to display notifications. The computing device 100 can be a tablet computing device, a smartphone, a personal digital assistant (PDA), a mobile device and/or any other computing device that may include a display member 150 (e.g., touchscreen or touch-enabled).

Display member 150 can be a touchscreen display of the computing device 100 to receive input and to display output to an operating user. For example, the display member 150 can be a capacitive touchscreen where a user's finger may function as a mouse and cursor to provide input and/or where a stylus pen may be used to provide input. Alternatively, or in addition, the display member 150 may provide or display an onscreen virtual keyboard for interacting with the computing device 100. Thus, the display member 150 can be a standalone tablet computing device or a smartphone for example.

Accessory member 140 can be an ultra-thin protective cover for the display member 150 of the computing device 100. Accessory member 140 can be attached or detached from the display member 150, as needed. Accordingly, accessory member 140 can be removably connected to the display member 150 via a mechanical connector and/or an electrical connector. In some examples, the accessory member 140 includes one or more built in magnets (not shown) at a bottom portion of the accessory member 140 to removably attach to the display member 150. It should be understood that other attachment mechanisms (e.g., latches) can. be provided in addition to, or as an alternative to magnets. Thus, the accessory member 140 can be placed in a closed position over the display member 150 or be placed in an open position to reveal the display member 150, while still attached to the display member 150.

In other examples, in addition to, or as an alternative to the mechanical connector, accessory member 140 may include one or more electrical connectors 130 to communicate electrical signals 120 between the accessory member 140 and the display member 150. For example, the electrical connectors 130 can be pogo® pins located at a bottom portion of the accessory member 140 to establish a connection between the accessory member 140 and the display member 150.

Electrical connectors 130 can convey electrical signals 120 that selectively light a plurality of light-emitting diodes (LEDs) in an accessory display 110 of the accessory member 140 to display notifications to the user when the accessory member 140 is placed in the closed position over the display member 150. The LEDs can be lit in the accessory display 110 to display notifications such as an email notification, message notification, time notification, battery status notification, etc. It should be understood that other light sources other than LEDs can be provided in the accessory display 110 to display the notifications.

In some examples, the user can select the types of notifications to be displayed in the accessory display 110 of the accessory member 140, and a duration of time for displaying the selected notifications. For example, a controller of display member 150 (not shown) can provide the user with options (e.g., via a graphical user interface (GUI)) for selecting types of notifications to display and how the selected notifications are to be displayed. To illustrate, the user may select one or more notifications, and select how long the notifications should remain on the accessory display 110 before entering a sleep (or power conserving) mode (i.e., disappearing).

Alternatively, or in addition, the user may select whether the notification should be displayed when content associated with the notification is received at the display member 150, or whether the notification should be displayed in response to the user swiping their finger over the accessory display. Accordingly, the user is provided with options for controlling and selecting notifications to be displayed and the manner of displaying the notifications. The controller of the display member 150 can be an operating system, software and/or firmware for controlling the notification display and for sending electrical signals 120 to the accessory display 110 to execute the notification display.

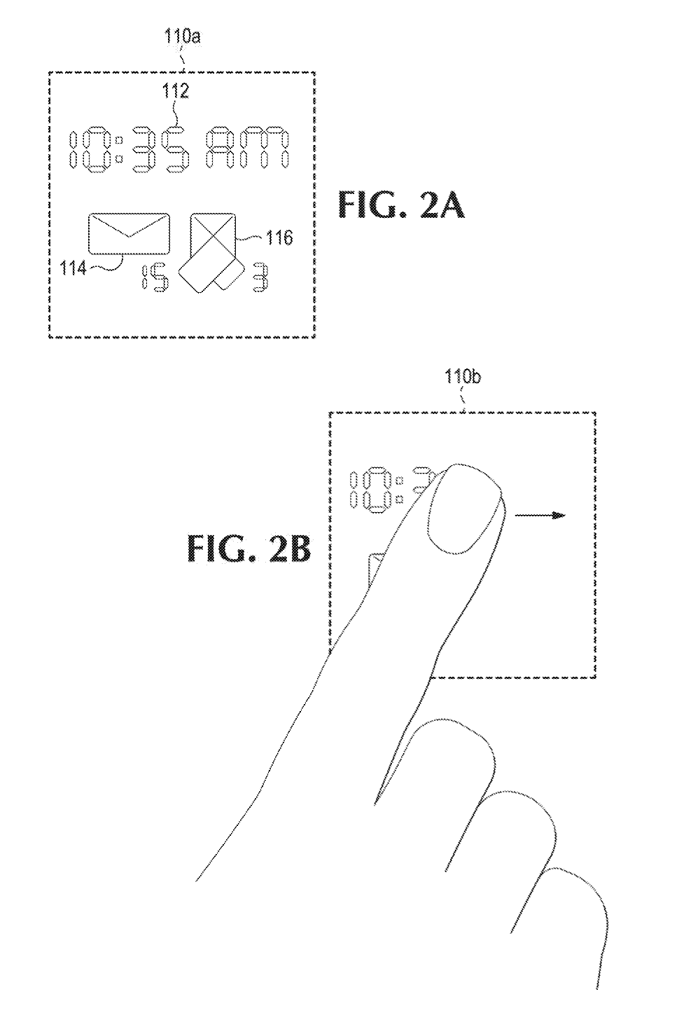

FIG. 2A illustrates examples of notifications that are displayed by an accessory display 110a of the accessory member 140 of FIG. 1. In the example of FIG. 2A, the accessory display 110a is located on the back side of the accessory member 140. In some examples, the accessory display 110a is a display area of the accessory member 140 to display notifications 112-116 when the accessory member 140 is placed over the display member 150.

The accessory display 110a receives electrical signals 120 that selectively light up a light source (e.g., LEDs) in the accessory display 110a based on the type of notifications 112-116 to be displayed. The notifications may include, for example, time notifications 112 (e.g., a digital clock), email notifications 114 (e.g., including a number of received emails), message notifications (e.g., a number of received short message service (SMS) or text message), multimedia messaging service (MMS) notifications, upload/download status notifications, Wi-Fi® connection status notifications, media player status notifications, missed call notifications, voicemail notifications, and/or my other type of notifications. It should be understood that more or less notifications can be displayed in the accessory display 110a than shown in FIG. 2A.

In some examples, the user may select the types of notifications to be displayed in the accessory display 110a, and how the selected notifications are to be displayed. For example, the user may elect to display particular notifications whenever content associated with the notifications are received by the computing device 100, and/or in response to the user swiping a finger across the accessory display 110a. Further, the user may determine how long the notifications 112-116 are displayed before the notifications 112-116 disappear, for example, to conserve power.

In certain examples, the accessory display 110a is to automatically adjust an orientation of the displayed notifications 112-116, such that the notifications 112-116 can be re-ad without having to rotate the computing device 100. To illustrate, if the user turns the computing device 100 around (e.g., upside down), the notifications 112-116 are displayed in an upright position such that the user does not need to rotate the computing device 100 to view the notifications 112-116.

FIG. 2B illustrates an example of an accessory display 110b of the accessory member 140 of FIG. 1 displaying notifications in response to a finger swipe. In the example of FIG. 2B, the accessory display 110b displays the notifications in response to the user swiping their finger across the accessory display 110b of the accessory member 140. For example, this may be an option that the user selects for displaying the notifications. In this example, power of the computing device 100 can be conserved because the notifications are displayed when needed.

As shown in the example of FIG. 2B, the notification is progressively displayed as the user swipes their finger across the accessory display 110b. For example, a portion of the time notification 112 and a portion of the email notification are progressively displayed in the accessory display 110b, as the user swipes their finger across the accessory display 110b.

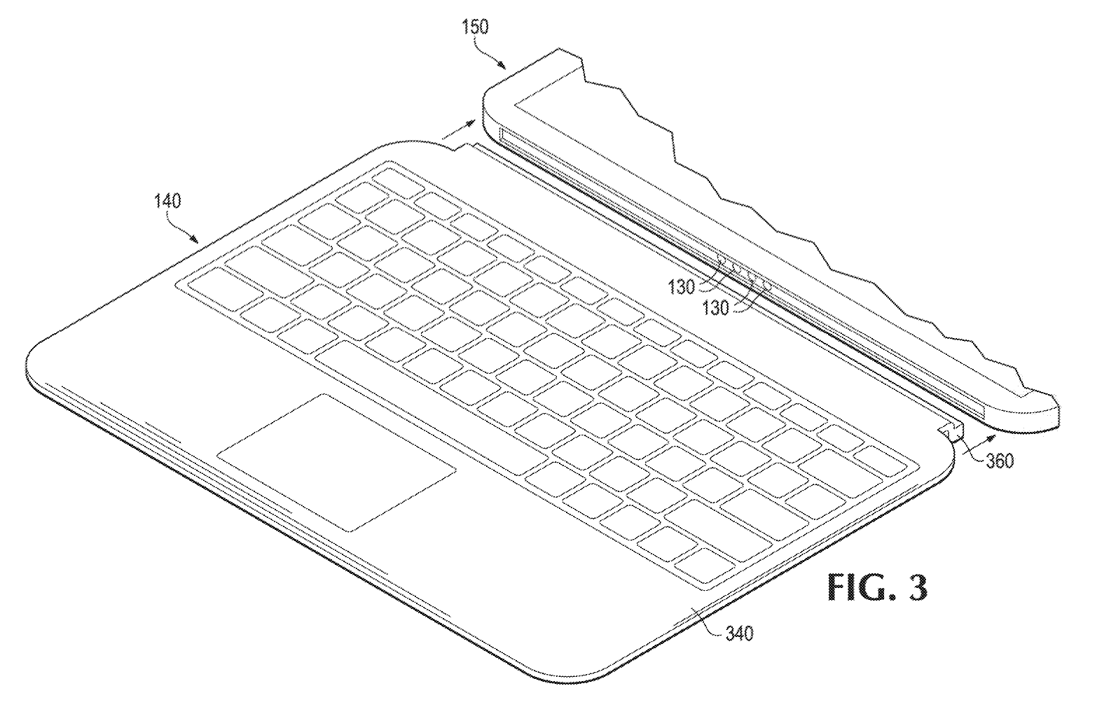

FIG. 3 illustrates an example of a protective cover for a computing device that includes a keyboard on a front side and a connector on a bottom side to removably connect to the computing device. Accessory member 140 can be a protective cover for the display member 150, where the display member 150 includes a touchscreen.

Accessory member 140 can removably connect to the display member 150 via as electrical connector 130 and/or a mechanical connector 360. In one example, the mechanical connector is a hinge 360 that may include magnets to latch onto a receiving portion on the display member 140 in the direction of the arrow shown. In other examples, the electrical connector 130 includes electrical pins (e.g., pogo® pins) located in a bottom portion of the display member, as shown, and/or located in a bottom portion of the accessory member 140. The electrical connector 130 may carry electrical signals between the display member 150 and the accessory member 140.

For example, display member may include a controller (not shown) that sends electrical signals to the accessory member 140 via the electrical connectors 130 to control display of notifications on the accessory member 140. The controller can be processor, a semi-conductor based microprocessor an integrated circuit (IC), or any other device suitable for managing the connection of the display member 150 with the accessory member 140.

As explained above, the accessory member 140 includes a front side 340 and a back side. The front side 340 includes keyboard (e.g., a QWERTY keyboard) for providing input to the display member 150. For example, when the accessory member 140 is in an open position, as shown in FIG. 3 the front side 340 including the keyboard is exposed and the user can use the keyboard to interact with the display member 150 when the accessory member 140 is attached/connected to the display member 150. As noted above, the accessory member 140 is ultra-thin, thereby maintaining a compact nature of the display member 150. Further, the accessory member 140 serves as a protective cover for the display member 150 when the accessory member is in a closed position over the display member 150. When the accessory member 140 is in a closed position over the display member 150, the back side of the accessory member 140 is revealed, where the back side includes an accessory display (i.e., a display area) for displaying notifications to the user.

In the foregoing description, numerous details are set forth to provide an understanding of the present disclosure. However, it will be understood, by those skilled in the art that the present disclosure may be practiced without these details. While the present disclosure has been disclosed with respect to a limited number of examples, those skilled in the art will appreciate numerous modifications and variations therefrom. It is intended that the appended claims cover such modifications and variations as fell within the true spirit and scope of the present disclosure.

What is claimed is:

1. A computing device comprising;
a display member;
an accessory member removably connected to the display member,
wherein the accessory member includes a frost side and a back side, and
wherein the back side includes an accessory display to display notifications whets the accessory member is in a closed position over the display member.

2. The computing device of claim 1, wherein the accessory member is a protective cover for the display member and is removably connected to the display member via at least one of an electrical connector and a mechanical connector.

3. The computing device of claim 2, wherein the electrical connector is to communicate electrical signal between the accessory member and the display member. cm 4. The computing device of claim 3, wherein the electrical signal is to selectively light a plurality of light-emitting diodes (LEDs) in the accessory display of the accessory member to display the notifications.

5. The computing device of claim 1, wherein the display member includes a controller to select notifications to be displayed and to set a duration of time for displaying the selected notifications, and wherein the selected notifications disappear after the duration of time.

6. The computing device of claim 1, wherein the notifications are displayed in response to a user swiping a finger across the accessory display.

7. The computing device of claim 1, wherein the notifications include at least one of an email notification, a time notification, a message notification, a battery status notification, a missed call notification, and a voicemail notification.

8. A protective cover for a computing device, comprising:
a front side;
a back side including a display area to display notifications to a user when the protective cover is placed over the computing device; and
a connector at a bottom portion of the protective cover to removably connect to the computing device.

9. The protective cover of claim 8, wherein the front side includes a keyboard to provide input to the computing device.

10. The protective cover of claim 8, wherein the connector includes at least one of an electrical connector and a mechanical connector.

11. The protective cover of claim 10, wherein the electrical, connector is to receive electrical signals from the computing device to selectively light a plurality of light-emitting diodes (LEDs) in the display area of the protective cover to display the notifications.

12. The protective cover of claim 10, wherein the electrical connector is to receive electrical signals from a controller of the computing device to select notifications to be displayed and a duration of time to display the selected notifications.

13. The protective cover of claim 10, wherein the mechanical connector includes at least one magnet to latch onto the computing device.

14. A computing device comprising;
a display member;
an accessory member removably connected to the display member,
wherein the accessory member includes a front side and a back side,
wherein the front side includes a keyboard, and
wherein the back side includes an accessory display to display notifications to a user when the accessory member is in a closed position over the display member, and in response to the user swiping a finger across the accessory display.

15. The computing device of claim 14, wherein the notifications include at least one of an email notification, a time notification, a message notification, a battery status notification, a missed call notification, and a voicemail notification.
